(19) United States
(12) Patent Application Publication
(10) Pub. No.: US 2025/0337246 A1
(43) Pub. Date: Oct. 30, 2025

(54) BALANCE CONTROL GENERATOR

(71) Applicant: Volvo Car Corporation, Göteborg (SE)

(72) Inventors: Vijay Arumugam, Västra Frölunda (SE); Ali Fotouhi, Kungsbacka (SE)

(73) Assignee: Volvo Car Corporation, Göteborg (SE)

(21) Appl. No.: 19/188,007

(22) Filed: Apr. 24, 2025

(30) Foreign Application Priority Data
Apr. 26, 2024 (EP) 24172733.8
Jun. 3, 2024 (EP) 24179630.9

(51) Int. Cl. H02J 3/28; B60L 15/00; H02J 3/14

(52) U.S. Cl. CPC H02J 3/28; B60L 15/007; H02J 3/14; B60L 2210/30; H02J 2310/12

(57) ABSTRACT

A control unit for controlling an electric power supply device, the electric power supply device being configured for power supply between an energy storage and a power grid which supplies electric power to a connection point, the power grid comprising a plurality of power conductors, the control unit being configured to receive first data indicative of exchanged electric power at the connection point, determine, using the first data, that a difference of exchanged power between a pair of power conductors among the plurality of power conductors is above a power threshold, and provide to the electric power supply a control signal indicative of a power setpoint for the energy storage.

### CROSS-REFERENCE TO RELATED APPLICATIONS

This application claims the benefits of European Patent Application Number 24172733.8 filed on Apr. 26, 2024, and European Patent Application Number 24179630.9 filed on Jun. 3, 2024, which is hereby incorporated by reference in its entirety.

### TECHNICAL FIELD

The present disclosure relates to a control unit and a method for controlling an electric power supply device, the electric power supply device being configured for power supply between an energy storage and a power grid which supplies electric power to a connection point.

### BACKGROUND

When multiple power generators and loads connected in a power grid connected house or a power generator generates power asymmetrically for local optimization in a power grid connected house, then the power fed back to the grid cannot exceed a certain threshold. Also, the power grid operators can set a power feed-in limit at grid connection point.

Implementing these requirements in electric vehicles results in poor customer experience because the generators may be not allowed to discharge to its maximum discharge power.

Therefore, there is a long felt need to optimize power exchange between the energy storage system and the power grid, ensuring smooth operation, compliance, and enhanced user satisfaction.

### SUMMARY

The following paragraphs present a summary to provide a basic understanding of one or more embodiments described herein. This summary is not intended to identify key or critical elements or delineate any scope of the different embodiments and/or any scope of the claims. The sole purpose of the summary is to present some concepts in a simplified form as a prelude to the more detailed description presented herein.

According to an embodiment, a control unit is provided, the control unit for controlling an electric power supply device, the electric power supply device being configured for power exchange between an energy storage and a power grid which supplies electric power to a connection point, the power grid comprising a plurality of power conductors, the control unit being configured to receive first data indicative of exchanged electric power at the connection point, determine, using the first data, that a difference of exchanged power between a pair of power conductors among the plurality of power conductors is above a power threshold, and provide to the electric power supply a control signal indicative of a power setpoint for the energy storage.

This allows to keep the amount of power difference or power asymmetry between two of the conductors below an allowed maximum (the power threshold) by using the energy storage. The control signal indicates a new setpoint for the energy storage. The updated setpoint will indicate the energy storage to draw or supply power from one or more of the conductors to ensure that the asymmetry among the currents in the plurality of conductors at the power grid connection point of the house is within the allowed limit set up by the service provider of the power grid.

When the electric power supply device is charging or discharging in a house, for instance with full power, and the house has other generating units or loads then the allowed maximum asymmetry limit between conductors can be violated. By implementing the described balance check function, the electric power supply device may act as an external balancing device and reduce the charging or discharging setpoint to protect the existing installation.

According to an embodiment, a method for controlling an electric power supply device is provided, the electric power supply device being configured for power supply between an energy storage and a power grid which supplies electric power to a connection point, the power grid comprising a plurality of power conductors, the method comprising receiving first data indicative of exchanged electric power at the connection point, determining, using the first data, that a difference of exchanged power between a pair of power conductors among the plurality of power conductors is above a power threshold, and providing to the electric power supply a control signal indicative of a power setpoint for the energy storage.

The control signal may indicate that the energy storage should supply power to or draw power from at least one of the plurality of power conductors of the power grid.

This allows the energy storage to compensate for the unallowed difference in power between conductors by reducing the charging or discharging power setpoint.

The power setpoint indicated by the control signal may be based on a maximum difference among differences of exchanged power between each pair of power conductors among the plurality of power conductors.

In this way, if there are several unallowed differences between conductors, the maximum one will be used to decide how much power the energy storage should charge or discharge in order to protect the power grid.

The power grid may comprise three power conductors. This is the usual number of conductors of power grids for houses. However, the power grid may comprise any other number of conductors.

The first data may be received from a measurement device connected to the connection point.

A control unit for controlling an electric power supply device, the electric power supply device being configured for power supply between an energy storage and a power grid which supplies electric power to a connection point, the control unit being configured to receive first data indicative of amount of power being supplied from the energy storage to the power grid, determine, using the first data, that the amount of power being supplied from the energy storage to the power grid exceeds a maximum allowed power, and provide to the electric power supply device a control signal indicating that the energy storage should reduce an amount of power being supplied from the energy storage to the power grid and should supply another amount of power from the energy storage to another energy storage.

This allows that, if the energy storage wants to supply to the power grid more than the maximum allowed power, this will be detected by the control unit and part of that power will be sent to another energy storage that could be in the same house where the vehicle is charging. The control unit can be in an electric power supply device arranged at the vehicle or in an external electric power supply device. The power grid can comprise one or any other number of conductors.

According to an aspect, the house comprises the electric power supply device and other loads and generators.

A method for controlling an electric power supply device, the electric power supply device being configured for power supply between an energy storage and a power grid which supplies electric power to a connection point, the method comprising receiving first data indicative of amount of power being supplied from the energy storage to the power grid, determining, using the first data, that the amount of power being supplied from the energy storage to the power grid exceeds a maximum allowed power, and providing to the electric power supply device a control signal indicating that the energy storage should reduce an amount of power being supplied from the energy storage to the power grid and should supply another amount of power from the energy storage to another energy storage.

The another energy storage may be arranged at a house and wherein the power grid is configured to supply power to the house.

The another amount of power supplied from the energy storage to the another energy storage may be based on the reduction of the amount of power being supplied from the energy storage to the power grid.

The another amount of power supplied from the energy storage to the another energy storage is equal to the reduction of the amount of power being supplied from the energy storage to the power grid. In this way, the power is efficiently used. This allows to use the energy storage at its full capacity.

The maximum allowed power of the power grid may be set up by a service provider managing the power grid.

According to an aspect, the control unit is connected through a communication line with the energy storage to receive the control signal via communication line.

According to an aspect, the energy storage is connected to and disconnected from the electric power supply device via the power cable.

The energy storage may be arranged at an electric vehicle.

According to an aspect, the electric power supply device communicates the control signal to the electric vehicle through communication lines and using a communication protocol.

According to an aspect, a communication unit is configured to transmit and receive signals from one of the electric vehicle and a measurement device.

According to an aspect, the vehicle comprising a Direct Current (DC) to Alternate Current (AC) and (AC) to (DC) converter.

According to another embodiment, an electric power supply device comprising any of the control units above described is provided.

According to another embodiment, an electric vehicle comprising any of the control units above described is provided.

According to an embodiment, the electric vehicle comprises an electric power supply device, the electric power supply device further comprising a control unit for controlling the electric power supply device, wherein the control unit is configured to receive first data indicative of exchanged electric power at a connection point, determine, using the first data, that a difference of exchanged power between a pair of power conductors among a plurality of power conductors is above a power threshold, provide to the electric power supply device a control signal indicative of a power setpoint for an energy storage, wherein the electric power supply device is configured for power supply between the energy storage and power grid with the plurality of power conductors supplying electric power to the connection point.

In this way, the energy storage will be able to help the power grid on restoring the asymmetry between lines or connectors to be within required limitations.

According to an aspect, a power connection comprising one of at least three conductors and current lines, each with different phase and corresponding to each phase of a power connector of the power grid.

The person skilled in the art will understand that the features described above may be combined in any way deemed useful.

### BRIEF DESCRIPTION OF THE DRAWINGS

The present disclosure will now be described in further detail with reference to the drawings that shows embodiments of the present disclosure:

FIG. 1A-I and FIG. 1A-II are schematics of a system for charging and/or discharging an energy storage according to at least one example of the disclosure.

FIG. 1B is a schematic of a system for charging and/or discharging an energy storage according to at least one example of the disclosure.

FIG. 2A is a flow chart of a method for controlling an energy storage according to at least one example of the disclosure.

FIG. 2B is a flow chart of a method for controlling an energy storage according to at least one example of the disclosure.

FIG. 3 is a schematic of a system for an electric power supply device comprising the control unit according to an example of the disclosure.

FIG. 4 shows a table to provide an example for the system of FIGS. 1A-i and 1A-ii according to an example of the disclosure.

### DETAILED DESCRIPTION

Embodiments of the present disclosure will be described herein below with reference to the accompanying drawings. However, the embodiments of the present disclosure are not limited to the specific embodiments and should be construed as including all modifications, changes, equivalent devices and methods, and/or alternative embodiments of the present disclosure.

The terms such as “first” and “second” as used herein may modify various elements regardless of an order and/or importance of the corresponding elements, and do not limit the corresponding elements. These terms may be used for the purpose of distinguishing one element from another element. For example, a first element may be referred to as a second element without departing from the scope the present disclosure, and similarly, a second element may be referred to as a first element.

The terms used in describing the various embodiments of the present disclosure are for the purpose of describing particular embodiments and are not intended to limit the present disclosure. As used herein, the singular forms are intended to include the plural forms as well, unless the context clearly indicates otherwise. All of the terms used herein including technical or scientific terms have the same meanings as those generally understood by an ordinary skilled person in the related art unless they are defined otherwise. The terms defined in a generally used dictionary should be interpreted as having the same or similar meanings as the contextual meanings of the relevant technology and should not be interpreted as having ideal or exaggerated meanings unless they are clearly defined herein. According to circumstances, even the terms defined in this disclosure should not be interpreted as excluding the embodiments of the present disclosure.

The term “vehicle” as used herein refers to a thing used for transporting people or goods. Automobiles, cars, trucks, or buses etc. are examples of vehicles. The term “vehicle” also includes electric vehicle (EV) powered by an electric motor that draws current from an on-vehicle energy storage device, such as a battery, which is rechargeable from an off-vehicle source, such as residential or public electric service or an on-vehicle fuel powered generator. The EV may be two or more wheeled vehicles manufactured for use primarily on public streets, roads. The EV may be referred to as an electric car, an electric automobile, an electric road vehicle (ERV), a plug-in vehicle (PV), a plug-in vehicle (xEV), etc., and the xEV may be classified into a plug-in all-electric vehicle (BEV), a battery electric vehicle, a plug-in electric vehicle (PEV), a hybrid electric vehicle (HEV), a hybrid plug-in electric vehicle (HPEV), a plug-in hybrid electric vehicle (PHEV), etc.

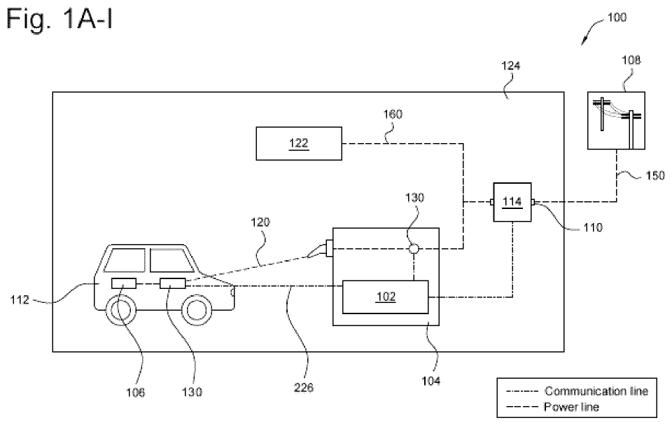

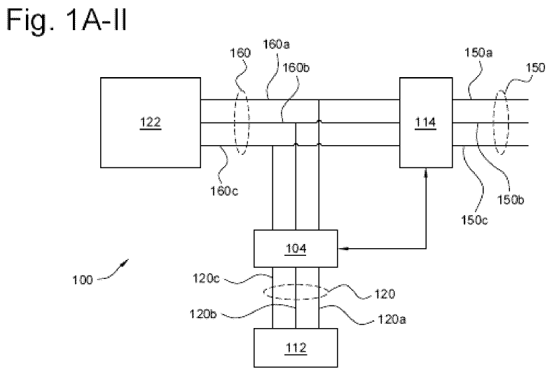

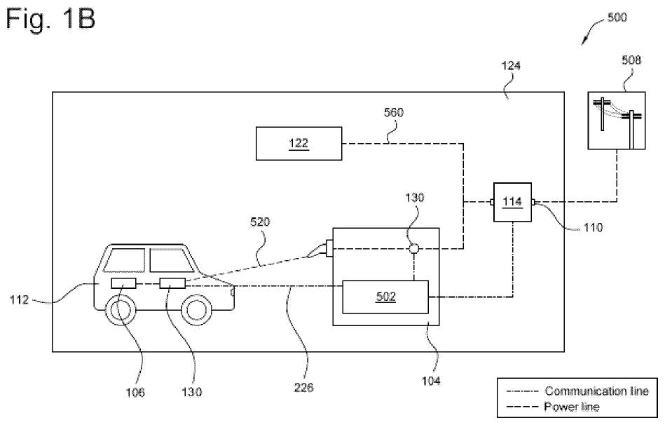

FIG. 1A-I and FIG. 1A-II are a schematic of a system 100 for charging an energy storage 106 according to at least one example of the disclosure.

The system 100 of FIG. 1A-I shows an electric vehicle 112 comprising an energy storage 106. The system 100 of FIG. 1A-I also shows an electric power supply device 104 connected to the power grid 108 via a connection point 110 of a house 124. The power grid 108 is a three-phase distribution network for transmitting electrical energy to the connection point 110. The power grid comprises three conductors or phase current lines 150a, 150b and 150c each with a different phase.

The house 124 comprises the electric power supply device 104 and other loads and/or generators 122 (such as, for instance, photovoltaic systems) belonging to the house 124 such that power exchange in both directions between the power grid 108 and the house 124 can take place through a power connection 160 connecting the power grid 108 to the electric power supply device 104 and to the other loads and/or generators 122. The power connection 160 comprises first, second and third conductors or current lines 160a, 160b and 160c each with a different phase such that a first phase of the first current line 160a of the power connection 160 corresponds to the first phase of the first power connector 150a of the power grid 150, a second phase of the second current line 160a of the power connection 160 corresponds to the second phase of the second power connector 150a of the power grid 150, and a third phase of the third current line 160a of the power connection 160 corresponds to the third phase of the third power connector 150a of the power grid 150. The electric power supply device 104 is connected to the electric vehicle 112 through the power cable 120 that also comprises first, second and third conductors or current lines 120a, 120b and 120c each with a different phase such that a first phase of the first current line 120a of the power cable 120 corresponds to the first phase of the first power connector 150a of the power grid 150, a second phase of the second current line 120a of the power cable 120 corresponds to the second phase of the second power connector 150a of the power grid 150, and a third phase of the third current electric vehicle line 120a of the power cable 120 corresponds to the third phase of the third power connector 150a of the power grid 150.

The energy storage 106 can be connected to and disconnected from the electric power supply device 104 via the power cable 120. In this way, when the energy storage 106 is connected to the electric power supply device 104, the energy storage 106 can supply power to the power grid 108 and can consume power from the power grid 108.

The electric vehicle 112 may comprise a Direct Current (DC) to Alternate Current (AC) (and AC to DC) converter, for instance as part of the power board measuring circuit 130. In this way, the electric power supply device 104 may act as a switch and allows the power to pass through it in both directions.

The electric power supply device 104 comprises the control unit 102. However, the control unit 102 may be also arranged at the electric vehicle 112. The control unit 102 is configured to receive first data indicative of indicative of exchanged electric power at the connection point 110. The control unit 102 is further configured to determine, using the first data, that a difference of exchanged power between a pair of power conductors among the plurality of power conductors 150 is above a power threshold. If the exchanged power between a pair of power conductors is above the power threshold, the control unit 102 is configured to provide to the electric power supply device 104 a control signal indicative of a power setpoint for the energy storage 106.

For instance, the control unit 102 may be connected through communication line 226 with the energy storage 106 such that the energy storage 106 may receive the control signal via communication line 226.

The first data indicative of exchanged electric power at the connection point 110 may be obtained based on power measurements of the exchanged power taken at the plurality of connectors 150 of the power grid.

As said, when the current or power amplitude difference between at least two of the current lines 150a, 150b and 150c is more than a power threshold, a control signal indicative of a power setpoint for the energy storage is provided to the electric power supply.

The control signal indicates that the energy storage should supply power to or draw power from at least one of the plurality of power conductors of the power grid.

For instance, the power setpoint indicated by the control signal may be based on a maximum difference among differences of exchanged power between each pair of power conductors among the plurality of power conductors.

Based on the power setpoint, the energy storage 106 may start charging power from one or more of the plurality of power connectors 150 of the power grid 108 or start discharging power to one or more of the plurality of power connectors 150 of the power grid 108.

In this way, the control unit 102 determines the power setpoint of the energy storage 106 of the electric vehicle 112 based on the first data. The electric power supply device 104 may communicate the power setpoint to the electric vehicle 112 through communication lines 226 and using a communication protocol such as ISO15118-2 or ISO15118-20 or IEC61851 or DIN 70121. However, any other communication standard may be used to communicate the possible/allowed operation such as wireless, Bluetooth etc.

Furthermore, when the current or power amplitude difference between the current lines 150a, 150b and 150c is less than the power threshold, the control unit 102 may provide a control signal indicative of an updated power setpoint for the energy storage 106 to the electric power supply 104.

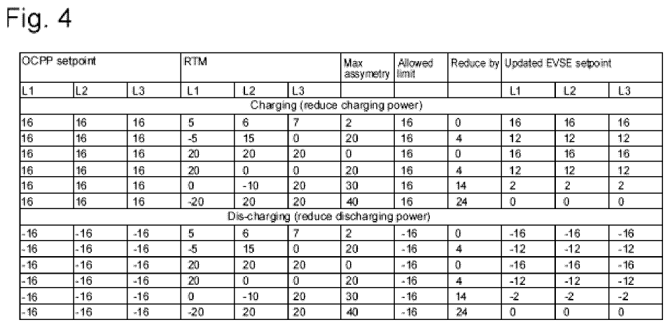

An example of how system of FIG. 1A-I and FIG. 1A-II may work will be explained now with respect to FIG. 4.

In FIG. 4, the meaning of each of the columns is indicated by the first row. The second row identifies the different phase lines. The third row indicates that the values of the following six rows after the third row relate to examples wherein the energy storage 106 is charging power (that is, draining power from the power grid 108). The tenth row indicates that the values of the following six rows after the tenth row relate to examples wherein the energy storage 106 is discharging power (that is, supplying power to the power grid 108).

The first three columns of FIG. 4 indicate a current setpoint for the energy storage 106, the next three columns after the first column indicate a power exchanged at the connection point 110, the seventh column indicates the maximum asymmetry calculated based on the values of the previous six columns, the eight one indicates the allowed limit (power threshold), the ninth column indicates which power reduction is needed based on the allowed limit and the maximum asymmetry and the last three columns indicate the updated setpoint for the energy storage 106 calculated.

For example, the fourth row indicates (first three columns of said row) that the energy storage 106 is draining 16 Volts from the first power connector 150a (L1) of the power grid 108, 16 Volts from the the second power connector 150b (L2) of the power grid 108, and 16 Volts from the the third power connector 150c (L3) of the power grid 108. The fourth to sixth columns of the fourth row indicate an exchanged power at the connection point 110 of 5 Volts at the the first power connector 150a (L1) of the power grid 108, 6 Volts at the the second power connector 150b (L2) of the power grid 108, and 7 Volts at the the third power connector 150c (L3) of the power grid 108. The ninth column of the fourth row indicates that the maximum difference of exchanged power between the different power connectors 150a, 150b and 150c of the power grid is 2 Amps (A) (the difference of exchanged power between L1 and L2 is equal to 6 A−5 A which is 1 A, the difference of exchanged power between L1 and L3 is 7 A−5 A which is 2 A, and the difference of exchanged power between L2 and L3 is equal to 7 A−6 A which is 1 A). As the maximum allowed asymmetry (power threshold) is 16 A as shown by the tenth column, the current setpoint should not be changed as indicated by the values of the last 5 columns of the fourth row.

As another example, let's look at the fifth row which indicates (first three columns of said row) that the energy storage 106 is draining 16 Volts from the first power connector 150a (L1) of the power grid 108, 16 A from the the second power connector 150b (L2) of the power grid 108, and 16 A from the the third power connector 150c (L3) of the power grid 108. The fourth to sixth columns of the fifth row indicate an exchanged power at the connection point 110 of −5 A at the the first power connector 150a (L1) of the power grid 108, 15 A at the the second power connector 150b (L2) of the power grid 108, and 0 A at the the third power connector 150c (L3) of the power grid 108. The ninth column of the fifth row indicates that the maximum difference of exchanged power between the different power connectors 150a, 150b and 150c of the power grid is 20 A (the difference of exchanged power between L1 and L2 is equal to 15 A−(−5) A which is 20 A, the difference of exchanged power between L1 and L3 is 15 A−0 A which is 15 A, and the difference of exchanged power between L2 and L3 is equal to 0 A−(−5) A which is 5 A). As the maximum allowed asymmetry (power threshold) is 16 A as shown by the tenth column, the maximum difference of exchanged power between the different power connectors 150a, 150b and 150c exceeds the power threshold in 4 A and the current setpoint should be changed as indicated by the values of the last 3 columns of the fifth row according to which the updated setpoint will indicate that the energy storage 106 should drain 12 A (4 A less than indicated by previous setpoint) from the first power connector 150a (L1) of the power grid 108, 12 A from the the second power connector 150b (L2) of the power grid 108, and 12 Volts from the the third power connector 150c (L3) of the power grid 108. In this way, the energy storage 106 contributes to the power grid 108 restoring required symmetry levels faster.

FIG. 1B is a schematic of a system 500 for charging an energy storage 106 according to at least one example of the disclosure. Same reference numbers as in relation to FIG. 1A-I have been used to indicate identical elements.

The system 500 of FIG. 1B shows an electric vehicle 112 comprising an energy storage 106. The system 500 of FIG. 1B also shows an electric power supply device 104 connected to the power grid 508 via a connection point 110 of a house 124. The power grid 508 comprises one conductors or current line. However, the power grid 508 may comprise any number of conductors or current lines.

The house 124 comprises the electric power supply device 104 and other loads and/or generators 122 (such as, for instance, photovoltaic systems) belonging to the house 124 such that power exchange in both directions between the power grid 508 and the house 124 can take place through a power connection 560 connecting the power grid 508 to the electric power supply device 104 and to the other loads and/or generators 122. The electric power supply device 104 is connected to the electric vehicle 112 through a power cable 520.

The energy storage 106 can be connected to and disconnected from the electric power supply device 104 via the power cable 520. In this way, when the energy storage 106 is connected to the electric power supply device 104, the energy storage 106 can supply power to the power grid 108 and can consume power from the power grid 108.

The electric vehicle 112 may comprise a Direct Current (DC) to Alternate Current (AC) (and AC to DC) converter, for instance as part of the power board measuring circuit 130. In this way, the electric power supply device 104 may act as a switch and allows the power to pass through it in both directions.

The electric power supply device 104 comprises the control unit 502. However, the control unit 502 may be also arranged at the electric vehicle 112. The control unit 502 is configured to receive first data indicative of amount of power being supplied from the energy storage 106 to the power grid 508. The control unit 502 is further configured to determine, using the first data, that the amount of power being supplied from the energy storage 106 to the power grid 508 exceeds a maximum allowed power.

If the control unit 502 determines that the amount of power being supplied from the energy storage 106 to the power grid 508 exceeds the maximum allowed power, the control unit 502 is configured to provide to the electric power supply device 104 a control signal that the energy storage 106 should reduce an amount of power being supplied from the energy storage to the power grid 508 and should supply another amount of power from the energy storage 106 to another energy storage among the other loads and/or generators 122.

For instance, the control unit 502 may be connected through communication line 226 with the energy storage 106 such that the energy storage 106 may receive the control signal via communication line 226.

When the control unit 502 determines that the amount of power being supplied from the energy storage 106 to the power grid 508 exceeds the maximum allowed power, the control unit 502 may provide a control signal indicating that the another amount of power that the energy storage 106 should supply to the another energy storage should be based on the reduction of the amount of power being supplied from the energy storage 106 to the power grid 508. Specifically, the another amount of power that the energy storage 106 should supply to the another energy storage may be equal to the reduction of the amount of power being supplied from the energy storage to the power grid.

The maximum allowed power of the power grid 508 may be set up by a service provider managing the power grid 508.

Based on the power grid 508 situation, the service provider managing the power grid 508 can impose an active power limitation on the generators. For example, if the energy storage 106 can produce 10 kilo Watts (kW) continuously, but the maximum allowed power is only 6 kW due to power grid constraints, the energy storage 106 may supply power at full capability and the excess power can be supply for house consumption behind the power grid connection point 110. In this way, the energy storage is optimally used.

The electric power supply device 104 may communicate the control signal to the electric vehicle 112 through communication lines 226 and using a communication protocol such as ISO15118-2 or ISO15118-20 or IEC61851 or DIN 70121. However, any other communication standard may be used to communicate the possible/allowed operation such as wireless, Bluetooth etc.

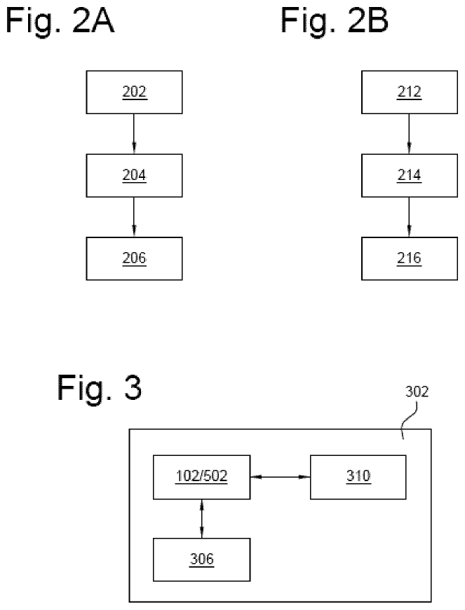

FIG. 2A shows a flowchart of a method for controlling an electric power supply device 104, the electric power supply device 104 being configured for power supply between an energy storage 106 and a power grid 108 which supplies electric power to a connection point 110 and the power grid 108 comprising a plurality of power conductors 150.

In step 202, the method of FIG. 2A receives first data indicative of exchanged electric power at the connection point 110.

In step 204, the method of FIG. 2A determines, using the first data, that a difference of exchanged power between a pair of power conductors among the plurality of power conductors 150 is above a power threshold.

After determining, in step 204, that the difference of exchanged electric power between a pair of power conductors among the plurality of power conductors 150 is above a power threshold, the method proceeds to step 206 and provides to the electric power supply device 104 a control signal indicative of a power setpoint for the energy storage 106.

The first data indicative of the difference of exchanged power at the connection point may be obtained based on a plurality of measurements of the exchanged power. For instance, at different times the electric power at each of a pair of conductors may be measured and a difference between the measured electric power at each conductor at each different time may be calculated. Then if more than a certain number of the calculated differences are above the power threshold, the method of FIG. 2A may determine in step 204 that the difference of exchanged electric power between the pair of power conductors is above the power threshold. The measured electric power may be stored in an internal memory.

FIG. 2B shows a flowchart of a method for controlling an electric power supply device 104, the electric power supply device 104 being configured for power supply between an energy storage 106 and a power grid 108 which supplies electric power to a connection point 110.

In step 202, the method of FIG. 2B receives first data indicative of amount of power being supplied from the energy storage 106 to the power grid 108.

In step 204, the method of FIG. 2B determines, using the first data, that the amount of power being supplied from the energy storage 106 to the power grid 108 exceeds a maximum allowed power.

After determining, in step 204, that the amount of power being supplied from the energy storage 106 to the power grid 108 exceeds the maximum allowed power, the method proceeds to step 206 and provides to the electric power supply device 104 a control signal indicating that the energy storage 106 should reduce an amount of power being supplied from the energy storage 106 to the power grid 108 and should supply another amount of power from the energy storage 106 to another energy storage among the other loads and/or generators 122.

FIG. 3 illustrates a block diagram of an apparatus 302 for an electric power supply device 104 comprising the control unit 102 and/or the control unit 502 configured to perform the method of FIG. 2A and/or the method of FIG. 2B. The apparatus 302 may comprise a control unit 102, a memory 306, and a communication unit 310. The control unit 102 and/or the control unit 502 may comprise a Central Processing Unit, CPU, which is connected to the memory 306, the communication unit 310.

The memory 306 may comprise any suitable known memory devices to store data and/or instructions to be run on the control unit 102 and/or the control unit 502, and may include any known type of volatile and non-volatile memory equipment, Random Access Memory (RAM) and Read Only Memory (ROM) types of memories, etc. The memory may be used to store the plurality of measurements to be used to determine whether the exchanged power between a pair of power conductors among the plurality of power conductors is above a power threshold in step 204 of the method of FIG. 2A.

The communication unit 310 is configured to transmit signals to and receive signals from equipment outside the control unit 102 and/or the control unit 502 such as the electric vehicle 112 or the measurement device 114. Any known and suitable transceiver equipment can be used for that purpose using any known or still to be developed (standard) communication technique including 2G, 3G, 4G, 5G, Wifi, Bluetooth, Near Field Communication (NFC), etc. To that end the communication unit 310 may be connected to a network and an antenna.

While the present disclosure has been described with reference to exemplary embodiments, it will be understood by those skilled in the art that various changes may be made, and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure is not limited to the particular embodiments disclosed, but that the present disclosure will include all embodiments falling within the scope of the appended claims.

As used herein, the terms “example” and/or “exemplary” mean serving as an example, instance, or illustration. For the avoidance of doubt, such examples do not limit the herein described subject matter. In addition, any aspect or design described herein as an “example” and/or “exemplary” is not necessarily preferred or advantageous over other aspects or designs, nor does it preclude equivalent exemplary structures and techniques known to those of ordinary skill in the art.

As used herein, the terms “include,” “have,” and any variations thereof, cover a non-exclusive inclusion such that a process, method, system, article, device, or apparatus that comprises a list of elements is not necessarily limiting to those elements, but may include other elements not expressly listed or inherent to such process, method, system, article, device, or apparatus.

No element act, or instruction used herein is critical or essential unless explicitly described as such. Furthermore, the terms “has,” “have,” “having,” or the like are open-ended terms. Further, the phrase “based on” means “based, at least in part, on” unless explicitly stated otherwise.

As used herein, the terms “system,” “device,” “unit,” and/or “module” refer to a different component, component portion, or component of the various levels of the order. However, other expressions that achieve the same purpose may replace the term.

As used herein, the term “or” is intended to be inclusive rather than exclusive. Unless specified otherwise or clear from the context, “X uses A or B” encompasses all possible combinations. This means that if X uses A, X uses B, or X uses both A and B, then “X uses A or B” is satisfied in any of these scenarios.

As used herein, the term “one of A, B, and C” shall be understood to mean “only A, only B, or only C,” and not a combination of A, B, and C.

As used herein, the term “one or more of A, B, and C” shall be understood to mean any one of A, B, or C, or any combination thereof, including multiple occurrences of each element. This includes, but is not limited to, the following configurations: only A, only B, only C, A and B, A and C, B and C, A, B, and C, as well as multiple instances of A, multiple instances of B, multiple instances of C, or any combination of multiple instances of A, B, and C.

While this specification contains many specifics, these do not construe as limitations on the scope of the disclosure or of the claims, but as descriptions of features specific to particular implementations. A single implementation may implement certain features described in this specification in the context of separate implementations. Conversely, multiple implementations separately or in any suitable sub-combination may implement various features described herein in the context of a single implementation. Moreover, although features described herein as acting in certain combinations and even initially claimed as such, one or more features from a claimed combination may in some cases be excised from the combination, and the claimed combination may be directed to a sub-combination or variation of a sub-combination.

Aspects of the one or more embodiments described herein are described with reference to flowchart illustrations and/or block diagrams of methods, apparatus (systems), and computer program products according to one or more embodiments described herein. Each block of the flowchart illustrations and/or block diagrams, and combinations of blocks in the flowchart illustrations and/or block diagrams, can be implemented by machine-readable storage program instructions. These computer-readable program instructions can be provided to a processor of a general-purpose computer, special purpose computer and/or other programmable data processing apparatus to produce a machine, such that the instructions, which execute via the processor of the computer or other programmable data processing apparatus, for implementing the functions/acts specified in the flowchart and/or block diagram block or blocks. These computer-readable program instructions can also be stored in a computer-readable storage medium that can direct a computer, a programmable data processing apparatus and/or other devices to function in a particular manner, such that the computer-readable storage medium having instructions stored therein can comprise an article of manufacture including instructions which can implement aspects of the function/act specified in the flowchart and/or block diagram block or blocks. The computer-readable program instructions can also be loaded onto a computer, other programmable data processing apparatus and/or other device to cause a series of operational acts to be performed on the computer, other programmable apparatus and/or other device to produce a computer implemented process, such that the instructions which execute on the computer, other programmable apparatus and/or other device implement the functions/acts specified in the flowchart and/or block diagram block or blocks.

Similarly, while operations depicted herein in the drawings in a particular order to achieve desired results, this should not be understood as requiring that such operations be performed in the particular order shown or in sequential order or that all illustrated operations be performed, to achieve desirable results. In certain circumstances, multitasking and parallel processing may be advantageous. Moreover, the separation of various system components in the implementations should not be understood as requiring such separation in all implementations, and it should be understood that the described program components and systems may be integrated together in a single software product or packaged into multiple software products.

Other specific forms may embody the present disclosure without departing from its spirit or characteristics. The embodiments described are in all respects illustrative and not restrictive. Therefore, the appended claims rather than the description herein indicate the scope of the disclosure. All variations which come within the meaning and range of equivalency of the claims are within their scope.

Even though particular combinations of features are recited in the claims and/or disclosed in the specification, these combinations are not intended to limit the disclosure of possible implementations. Other implementations are within the scope of the claims. For example, the actions recited in the claims may be performed in a different order and still achieve desirable results. In fact, many of these features may be combined in ways not specifically recited in the claims and/or disclosed in the specification. Although each dependent claim may directly depend on only one claim, the disclosure of possible implementations includes each dependent claim in combination with every other claim in the claim set.

1. A control unit comprising a central processing unit, which is connected to a memory and a communication unit, wherein the control unit is configured to:
receive first data indicative of exchanged electric power at a connection point;
determine, using the first data, that a difference of exchanged power between a pair of power conductors among a plurality of power conductors is above a power threshold;
provide to an electric power supply device a control signal indicative of a power setpoint for an energy storage;
wherein the control unit is configured for controlling the electric power supply device; and wherein the electric power supply device is configured for power supply between the energy storage and power grid comprising the plurality of power conductors supplying electric power to the connection point.

2. The control unit of claim 1, wherein the control signal indicates that the energy storage performs one of supply power to and draw power from at least one of the plurality of power conductors of the power grid.

3. The control unit of claim 1, wherein the power setpoint indicated by the control signal is based on a maximum difference among differences of exchanged power between the pair of power conductors among the plurality of power conductors.

4. The control unit of claim 1, wherein the power grid comprises three power conductors.

5. The control unit of claim 1, wherein the first data is received from a measurement device connected to the connection point.

6. A control unit comprising a central processing unit, which is connected to a memory and a communication unit, wherein the control unit is configured to:
receive first data indicative of a first amount of power supplied from a first energy storage to a power grid;
determine, using the first data, that the first amount of power supplied from the first energy storage to the power grid exceeds a maximum allowed power;
provide to an electric power supply device a control signal indicating the first energy storage to reduce the first amount of power supplied from the first energy storage to the power grid and to supply second amount of power from the first energy storage to a second energy storage;
wherein the control unit is used for controlling the electric power supply device; and
wherein the electric power supply device is configured for power supply between the first energy storage and power grid with a plurality of power conductors, supplying electric power to a connection point.

7. The control unit according to claim 6, wherein the second energy storage is arranged at a house and wherein the power grid is configured to supply power to the house.

8. The control unit of claim 6, wherein the second amount of power supplied from the first energy storage to the second energy storage is based on a reduction of the first amount of power supplied from the first energy storage to the power grid.

9. The control unit of claim 8, wherein the second amount of power supplied from the first energy storage to the second energy storage is equal to the reduction of the amount of power supplied from the energy storage to the power grid.

10. The control unit of claim 6, wherein the maximum allowed power of the power grid is set up by a service provider managing the power grid.

11. The control unit of claim 6, wherein the first energy storage is arranged at an electric vehicle.

12. The control unit of claim 6, wherein the electric power supply device is used as an external balancing device and to reduce one or more of a charging and a discharging setpoint.

13. The control unit of claim 6, wherein the control unit is connected through a communication line with the first energy storage to receive the control signal via the communication line.

14. The control unit of claim 6, wherein the first energy storage is one of connected to and disconnected from the electric power supply device via a power cable.

15. The control unit of claim 7, wherein the house comprises one or more of the electric power supply device, loads, and generators.

16. The control unit of claim 1, wherein a power connection comprising one of at least three conductors and current lines, each with different phase and corresponding to each phase of a power connector of the power grid.

17. An electric vehicle comprising an electric power supply device, the electric power supply device further comprising a control unit for controlling the electric power supply device, wherein the control unit is configured to:
receive first data indicative of exchanged electric power at a connection point;
determine, using the first data, that a difference of exchanged power between a pair of power conductors among a plurality of power conductors is above a power threshold;
provide to the electric power supply device a control signal indicative of a power setpoint for an energy storage; and
wherein the electric power supply device is configured for power supply between the energy storage and power grid with the plurality of power conductors supplying electric power to the connection point.

18. The electric vehicle of claim 17, wherein the electric power supply device communicates the control signal to the electric vehicle through communication lines and using a communication protocol.

19. The electric vehicle of claim 17, wherein a communication unit is configured to transmit and receive signals from one of the electric vehicle and a measurement device.

20. The electric vehicle of claim 17, wherein the vehicle comprises a Direct Current (DC) to Alternate Current (AC) and (AC) to (DC) converter.
